(19) United States
(12) Patent Application Publication
(10) Pub. No.: US 2023/0200556 A1
(43) Pub. Date: Jun. 29, 2023

(54) CHAIR

(71) Applicant: Halu Inc., Kyoto (JP)

(72) Inventors: Andrea PAVAN, Lisboa (PT); Chris PEARCE, Tokyo (JP); Florian GERLACH, Lisboa (PT); Kenta KONDO, Tokyo (JP); Jinji MIYAUCHI, Aichi (JP); Yuri MATSUMOTO, Kyoto (JP)

(21) Appl. No.: 17/928,512

(22) PCT Filed: Mar. 22, 2021
(86) PCT No.: PCT/JP2021/011699

§ 371 Date: Nov. 29, 2022

(51) Int. Cl. A47D 1/10; A47C 3/16; A47C 4/04; A61G 5/12

(52) U.S. Cl. CPC A47D 1/10; A47C 3/16; A47C 4/04; A61G 5/121; A61G 5/122

(57) ABSTRACT

In order to satisfy a conventional demand from users for easily portable chairs that can be used in a variety of situations, a chair includes: a main body having a seat surface and capable of being installed on an installation plane; and a backrest rotatably attached to the main body. The chair is configured to have a box-like shape having one or more faces that are positioned so as to cover two lateral sides and an upper side of the seat surface in a folded state in which the backrest covers the upper side of the seat surface. The one or more faces are constituted by outer surfaces of the main body and an outer surface of the backrest. This chair can be easily carried to various places.

### TECHNICAL FIELD

The present invention relates to a portable chair.

### BACKGROUND ART

Various portable chairs are known. For example, Patent Document 1 below describes a table chair including a framework constituted by pipes and the like and a seat cover assembled to the framework. This table chair is configured to be foldable and portable.

Some chairs have a sitting posture maintaining function to maintain the seated user’s posture (sitting posture) (see Patent Document 2 below, for example). Such chairs can be used, for example, for users who have difficulty in maintaining a sitting posture by themselves due to a functional disability in a part of their body. The function of such chairs makes it easier for the users to maintain a sitting posture.

### CITATION LIST

### Patent Documents

Patent Document 1: JP 2006-150104A
Patent Document2: Japanese Unexamined Utility Model Application Publication No. H6-427

### SUMMARY OF INVENTION

### Technical Problem

Table chairs such as those described in Patent Document 1 above can be attached to a table or other structure during use. However, the situations in which chairs are used are not limited to those described above. That is to say, there is a demand from users for easily portable chairs that can be used in a variety of situations.

It is an object of the present invention to provide an easily portable chair.

### Solution to Problem

A first aspect of the present invention is directed to a chair including: a main body having a seat surface and capable of being installed on an installation plane; and a backrest rotatably attached to the main body, wherein the chair is configured to have a box-like shape having one or more faces that are positioned so as to cover two lateral sides and an upper side of the seat surface in a folded state in which the backrest covers the upper side of the seat surface, and the one or more faces are constituted by an outer surface of the main body and an outer surface of the backrest.

With this configuration, it is possible for a user to easily carry the chair.

Furthermore, a second aspect of the present invention is directed to the chair according to the first aspect, further including a support member attached to an inner side of the backrest where a seated user is located and capable of supporting the upper body of the seated user, wherein the support member is attached so as to face the seat surface in the folded state.

With this configuration, it is possible to easily carry the chair capable of maintaining the user’s sitting posture.

Furthermore, a third aspect of the present invention is directed to the chair according to the second aspect, wherein the main body has a recess configured to accommodate the buttocks of the seated user, a bottom of the recess is configured to serve as the seat surface, and the recess is configured such that the support member fits into the recess in the folded state.

With this configuration, it is possible to reduce the size of the chair in the folded state.

Furthermore, a fourth aspect of the present invention is directed to the chair according to the second or third aspect, wherein the support member is configured to be slidable in a predetermined direction against the backrest.

With this configuration, it is possible for the chair to support the user’s upper body according to each user’s physique.

Furthermore, a fifth aspect of the present invention is directed to the chair according to any one of the second to fourth aspects, further including a headrest arranged inside the backrest and capable of supporting the head of the seated user, wherein the headrest is displaceable in a predetermined direction with respect to the support member, and the headrest and the support member are configured to overlap in this order in the direction from the inside to the outside in the folded state.

With this configuration, it is possible for the chair to support the user’s head.

Furthermore, a sixth aspect of the present invention is directed to the chair according to any one of the first to fifth aspects, further including a strap capable of engaging with the main body, wherein the strap is configured to be changeable in length.

With this configuration, it is possible for a user to more easily carry the chair in the folded state and to regulate the position of the chair with respect to the installation plane when the chair is used, using the strap.

Furthermore, a seventh aspect of the present invention is directed to the chair according to any one of the first to sixth aspects, further including a projecting member arranged so as to project rearward from a rear end of the main body and configured to restrict rearward rotation of the entire main body with respect to the installation plane, wherein the projecting member is displaceable with respect to the main body so as not to project rearward from the main body.

With this configuration, it is possible to stably use the chair on the installation plane.

Furthermore, an eighth aspect of the present invention is directed to the chair according to any one of the first to seventh aspects, wherein the main body includes: a seat unit provided with the seat surface; and a supporting contact member arranged at a bottom of the main body and configured to be in contact with the installation plane, thereby supporting the seat unit, and the supporting contact member is configured to be displaceable at least between a first position and a second position with respect to the seat unit.

With this configuration, it is possible to change the angle of the chair on the installation plane.

### Advantageous Effects of Invention

According to the present invention, it is possible to provide a chair that can be easily carried to various places.

### BRIEF DESCRIPTION OF DRAWINGS

FIG. 1 is a perspective view of a chair in an embodiment.

FIG. 2 is a perspective view of the chair viewed from below in the embodiment.

FIG. 3 is an exploded perspective view showing the schematic configuration of the chair in the embodiment.

FIG. 4 is a side view of the chair in the embodiment.

FIG. 5 is a rear view of the chair in the embodiment.

FIG. 6 is a front view of the chair in the embodiment.

FIG. 7 is a plan view of the chair in the embodiment.

FIG. 8 is a bottom view of the chair in the embodiment.

FIG. 9 is a side view showing a tilted state of the chair in the embodiment.

FIG. 10 is a side view showing an example of the state in which a support member of the chair is displaced in the embodiment.

FIG. 11 is a perspective view showing an example of the state in which accessory members are attached to the chair in the embodiment.

FIG. 12 is a side view showing a usage example of the chair in the embodiment.

FIG. 13 is a perspective view showing a folded state of the chair in the embodiment.

FIG. 14 is a front view showing a folded state of the chair in the embodiment.

FIG. 15 is a view illustrating a shifting procedure from a folded state to a usable state of the chair in the embodiment.

FIG. 16 is a side view of the chair according to a modified example of the present invention.

FIG. 17 is a side view showing a state in which the chair is tilted in the embodiment.

### DESCRIPTION OF EMBODIMENT

Hereinafter, an embodiment of the chair and the like will be described with reference to the drawings. It should be noted that constituent elements denoted by the same reference numerals in the embodiments perform similar operations, and thus a description thereof may not be repeated.

In the description below, the coordinates shown in the drawings are common among the drawings. A Z direction (positive on the Z axis) of the coordinates is an upward direction that is perpendicular to the horizontal plan. A downward direction is opposite to the upward direction. AY direction (positive on the Y axis) is a rightward direction that is perpendicular to the Z direction. The rightward direction is the right-hand direction, as viewed from a user seated in the chair in the normal way. A leftward direction is opposite to the rightward direction. An X direction is a direction that is perpendicular to the Z direction and perpendicular to the Y direction. The Y direction can be said to be the rearward direction, as viewed from a user seated in the chair in the normal way. A frontward direction is opposite to the rearward direction. When describing each part of the chair by indicating the above directions, the position of the part is described in a usable state in which a user can be seated, unless otherwise noted. The direction shown in the following description of the chair in the usable state corresponds to the direction as viewed from a user seated in the chair in the normal way. Although the shape and positional relationship of parts may be described by indicating each direction in this manner in the following description, these are defined only for convenience of explanation and do not limit the orientation or posture of the chair according to the present invention during use.

### Embodiments

In this embodiment, the chair is a chair that can maintain the seated user’s posture. The chair can be used by infants and toddlers whose trunk support capabilities are immature and users who have difficulty in maintaining a sitting posture by themselves due to a functional disability in a part of their body, for example. Such a function of the chair makes it easier for the users to maintain a sitting posture. However, the applications of the chair are not limited to those described above. For example, the chair may be configured for use by infants and children with developed body functions, as well as adults.

In this embodiment, the chair has a backrest that is rotatable with respect to a main body having a seat surface. The chair is configured to have a box-like shape as a whole when it is shifted from a usable state in which a user can be seated to a folded state in which the backrest has rotated with respect to the main body. That is to say, the chair is configured to have a box-like shape as a whole in the folded state in which the chair is folded and easy to carry. In other words, the rear side of the backrest of the chair is provided with an outer surface that constitutes part of the outer surface of the box-like shape in the folded state. Hereinafter, the thus configured chair will be described with reference to the drawings.

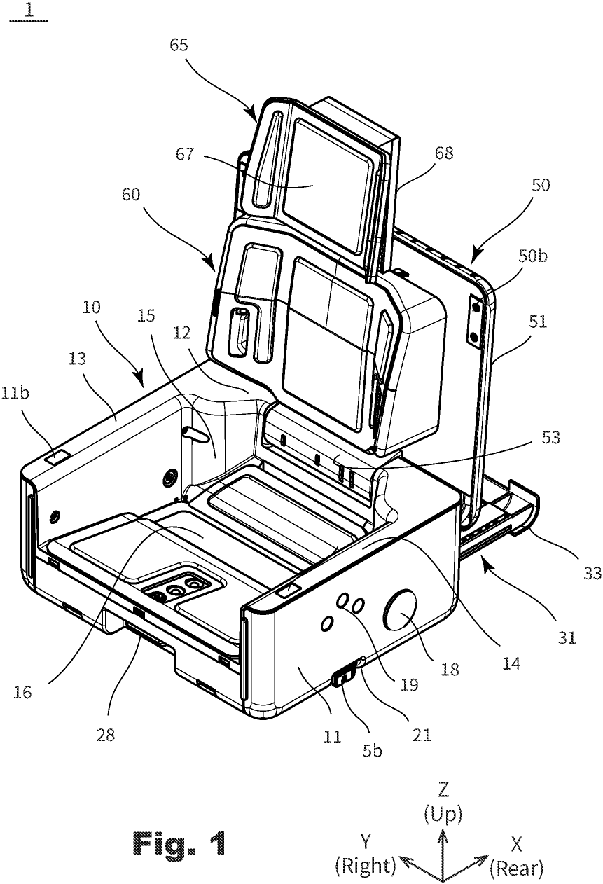

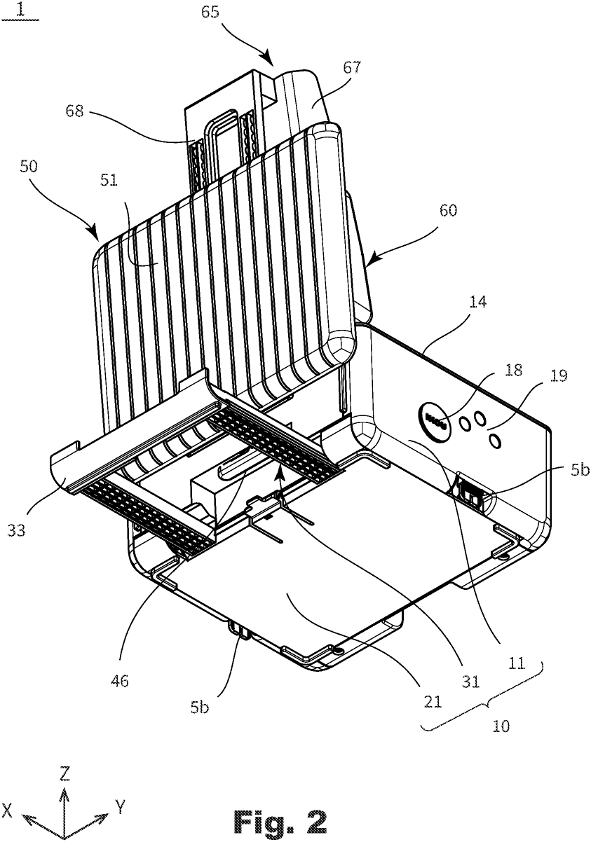

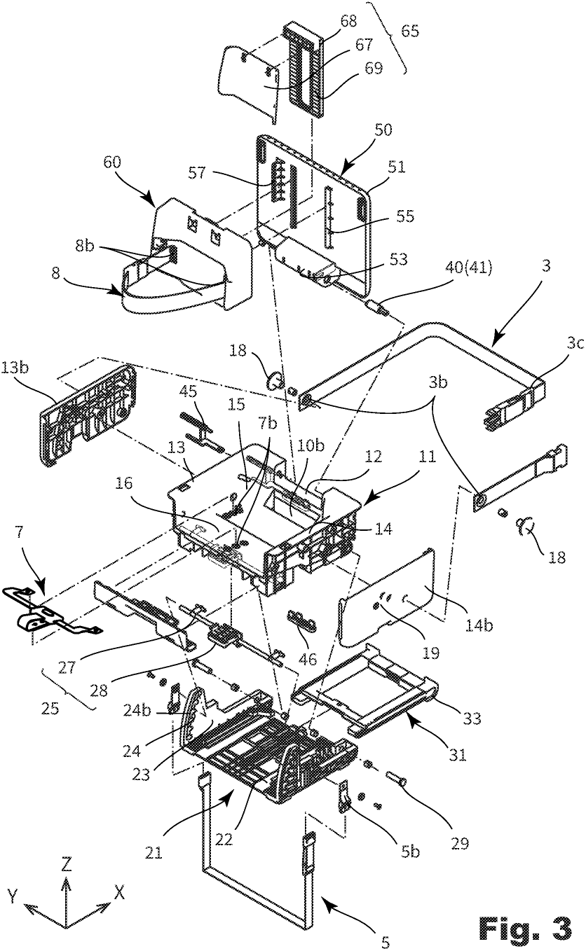

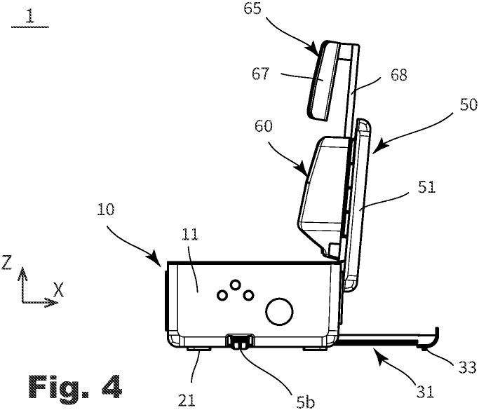

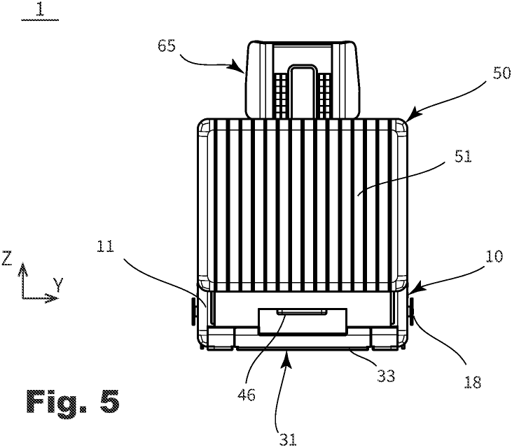

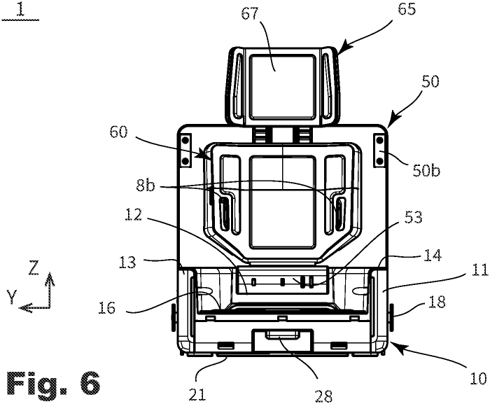

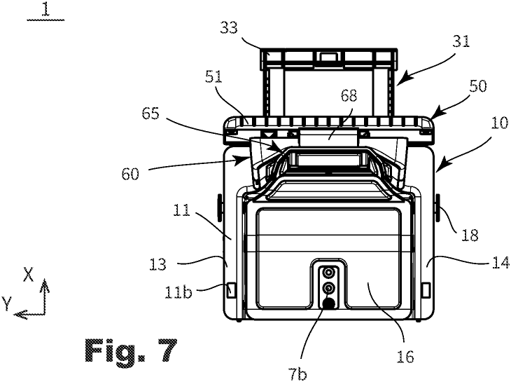

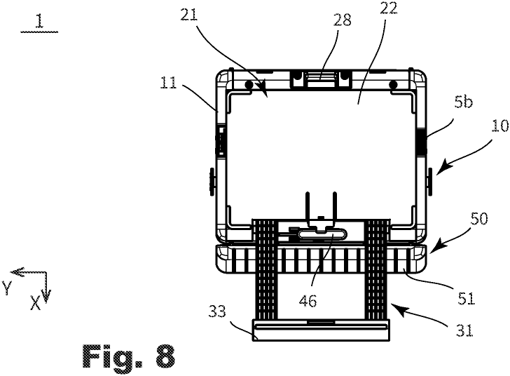

FIG. 1 is a perspective view of a chair 1 in this embodiment. FIG. 2 is a perspective view of the chair 1 viewed from below. FIG. 3 is an exploded perspective view showing the schematic configuration of the chair 1. FIG. 4 is a side view of the chair 1. FIG. 5 is a rear view of the chair 1. FIG. 6 is a front view of the chair 1. FIG. 7 is a plan view of the chair 1. FIG. 8 is a bottom view of the chair 1.

As shown in the drawings, the chair 1 includes a main body 10, a shaft 40, a backrest 50, a support member 60, a headrest 65, and a projecting member 31. The chair 1 has a basic structure in which the backrest 50 is rotatably attached to the main body 10. In this embodiment, the support member 60 is attached to the backrest 50. The headrest 65 is attached to the support member 60.

The drawings may not show some of the constituent elements. For example, FIG. 3 shows only main constituent elements out of those constituting the chair 1. FIG. 3 does not show some of relatively small constituent elements such as screws. In this embodiment, covers having a cushioning function may be attached to the surfaces of a later-described seat surface 16, the support member 60, and a pad 67 of the headrest 65, but FIG. 3 does not show such covers. The chair 1 may be used with or without such covers attached. FIG. 3 shows accessory members as described later. The accessory members will be described in detail. The thin lines shown in the drawings indicate the change in surface shape, and are not lines that represent a pattern but lines that represent the shape of the three-dimensional surface.

The main body 10 is a portion that can be installed on an installation plane. The installation plane may be any plane such as a floor surface, an upper face of various structures, or a seat surface of other chairs or benches, or the like, for example. The main body 10 is configured to be in contact with the seated user’s buttocks. That is to say, the user can use the chair 1 by sitting on the seat surface 16 provided on the main body 10. In this embodiment, the main body 10 are substantially in the shape of a cuboid as a whole. The main body 10 has a recess 15 that is recessed down from the upper face so as to accommodate the seated user’s buttocks. The main body 10 is configured such that the seat surface 16 is the bottom of the recess 15. In other words, the recess 15 includes the seat surface 16.

In this embodiment, the main body 10 includes a seat unit 11, a supporting contact member 21, and an angle change mechanism 25, for example. The projecting member 31 is attached to the main body 10. The main body 10 may also be said to include the projecting member 31.

The seat unit 11 is provided with the seat surface 16. The seat unit 11 is formed by combining multiple divided resin components, for example. In this embodiment, the seat unit 11 includes a component provided with the recess 15 so as to include the seat surface 16, and side panels 13b and 14b that are attached to the left and right sides of the component, as shown in FIG. 3. The component configuration of the seat unit 11 is not limited to this, and various dividing methods may be used. It may also be molded from a single resin component. In this embodiment, the resin components refer to a component substantially made of resin, and may include a part that is not made of resin. The seat unit 11 may be formed using a material that is not resin. For example, the side panels 13b and 14b may be made of sheet metal.

The seat unit 11 includes a holding portion 12, a right armrest 13, a left armrest 14, strap engageable portions 18, and table attachment portions 19.

The holding portion 12 is located at the top of the seat unit 11, near the rear end of the seat unit 11. The holding portion 12 is located on the rear side of the recess 15. The holding portion 12 rotatably holds a support portion 53 of the backrest 50. The holding portion 12 holds the support portion 53 via the shaft 40. The holding portion 12 may be described as a portion that holds the rotational shaft of the backrest 50.

The right armrest 13 is located on the right side of the recess 15. The left armrest 14 is located on the left side of the recess 15. That is to say, the right armrest 13 and the left armrest 14 are aligned in the left-right direction so as to have the recess 15 and the seat surface 16 therebetween. In this embodiment, the upper ends of the right armrest 13 and the left armrest 14 are upper faces of the seat unit 11. The upper ends of the right armrest 13 and the left armrest 14 are above the seat surface 16. The right outer surface of the right armrest 13 and the left outer surface of the left armrest 14 are in the shape of flat faces that are perpendicular to the Y direction. The outer surfaces each have a substantially rectangular shape as viewed from a side. The right armrest 13 and the left armrest 14 are referred to as armrests only for convenience of explanation. The armrests 13 and 14 may not be formed so as to form a suitable portion for a user seated in the chair 1 to place his/her elbows.

Since the holding portion 12, the right armrest 13, and the left armrest 14 are formed in this manner, the recess 15 is formed so as to be recessed down from the upper side of the seat unit 11. The holding portion 12, the right armrest 13, and the left armrest 14 are formed so as to surround the rear, right, and left sides of the seat surface 16 at the bottom of the recess 15. The front side of the seat surface 16 is open. The recess 15 is configured to accommodate the seated user’s buttocks. When the user’s buttocks are accommodated in the recess 15, the user’s thighs and knees can be positioned in the open front portion of the seat surface 16. The seat surface 16 may be configured to slope downward from the front end where the knees are located to the rear when the chair 1 is not tilted. This allows the user to be seated in a posture in which the user’s center of gravity is positioned lower in the chair 1 and the user can easily maintain the seated state.

The strap engageable portions 18 are respectively located on the right outer surface of the right armrest 13 and the left outer surface of the left armrest 14. The strap engageable portions 18 are portions that are configured to engage with strap attachment portions 3b at the two ends of a strap 3, as described later. In this embodiment, the strap engageable portions 18 are shaft-attached caps that are inserted into holes formed through the strap attachment portions 3b (an example of engagement) and are fixed to the seat unit 11, for example. The configuration of the strap engageable portions 18 is not limited to this, and various forms may be employed. The strap engageable portions 18 are positioned closer to the rotational shaft of the backrest 50 with respect to the main body 10 than to the center of gravity of the chair 1 in a later-described folded state as viewed in the left-right direction. That is to say, the strap 3 is attached to the main body 10 at a position closer to the rotational shaft of the backrest 50 than to the center of gravity of the chair 1 in the folded state. This makes it easier to maintain the backrest 50 in the closed state when the chair 1 is suspended by the strap 3 in the folded state.

The table attachment portions 19 are respectively located on the right outer surface of the right armrest 13 and the left outer surface of the left armrest 14. Table props 93 of a table 91, which are accessory members, can be attached to the table attachment portions 19, as will be described later. Specifically, the table attachment portions 19 each have three screw holes, for example. The table attachment portions 19 are configured such that the table props 93 can be attached to and detached from the table attachment portions by means of a screw-based fastening method, for example. That is to say, the table props 93 can be attached to and detached from the main body 10. The number, position, shape, and the like of the screw holes of the table attachment portions 19 are not limited to this. The table attachment portions 19 may be configured such that the table props 93 can be attached to the table attachment portions by means of a fastening method using magnetic force or the elasticity of resin, for example.

As shown in FIG. 3, the supporting contact member 21 is located at the bottom of the main body 10. The supporting contact member 21 is located below the seat unit 11. The supporting contact member 21 is in contact with the installation plane on which the chair 1 is installed, thereby supporting the seat unit 11.

In this embodiment, the rear end of the supporting contact member 21 is rotatably attached to the seat unit 11. For example, rotational shafts 29 are attached parallel to the Y direction at the lower rear ends on the left and right sides of the seat unit 11. The supporting contact member 21 is attached to the seat unit 11 via the rotational shafts 29 such that the rotational shafts 29 penetrate bearings. That is to say, the seat unit 11 is rotatable with respect to the supporting contact member 21 about the rotational shafts 29 that are parallel to the Y axis provided at the lower rear end of the seat unit.

The supporting contact member 21 includes a bottom portion 22, rising portions 23, and engageable portions 24. The supporting contact member 21 is a resin component, for example, but is not limited to this. For example, it may be made of sheet metal. The supporting contact member 21 may be formed by combining multiple separately formed components.

The bottom portion 22 is a substantially horizontally formed platelike portion that covers the bottom of the seat unit 11. The bottom portion 22 has a substantially rectangular shape as viewed from below.

The rising portions 23 are portions formed so as to rise upward from the bottom portion 22. In this embodiment, the rising portions 23 are formed at the left and right ends of the bottom portion 22. The rising portions 23 are formed in the shape of flat plates substantially perpendicular to the Y direction. That is to say, the rising portions 23 are substantially perpendicular to the rotational shafts 29. The left and right rising portions 23 are respectively accommodated inside the left armrest 14 and the right armrest 13.

The engageable portions 24 are portions configured to be capable of engaging with an engageable member 27 of the angle change mechanism 25. In this embodiment, the engageable portions 24 are formed in the rising portions 23. The engageable portions 24 are formed at multiple locations at equal distances from the corresponding rotational shaft 29, for example. The engageable portions 24 are located so as to be capable of engaging with the engageable member 27 when the position of the supporting contact member 21 relative to the seat unit 11 is a predetermined position. In this embodiment, for example, the rising portions 23 each have the engageable portions 24 that are multiple through-holes and one elongated hole portion 24b that is formed so as to be connected to the through holes. The multiple through-holes are formed at multiple locations whose distance from the corresponding rotational shaft 29 is a first dimension. The elongated hole portion 24b is formed along an arc about the rotational shaft 29 whose radius matches a second dimension that is slightly larger than the first dimension. The multiple through-holes are formed in pairs with each other in the left and right rising portions 23.

The angle change mechanism 25 in this embodiment has the engageable member 27 and a tilting operation portion 28. In this embodiment, the angle change mechanism 25 is located in the front portion of the seat unit 11 and below the seat surface 16.

The engageable member 27 is a rod-like component parallel to the Y direction, for example. The engageable member 27 is held in the seat unit 11 while being biased rearward by a spring or the like, for example. The two ends of the engageable member 27 are held in a fitted (engaged) state in one of the multiple pairs of engageable portions 24 that are paired on the left and right sides.

The tilting operation portion 28 is attached to the engageable member 27. The tilting operation portion 28 has a lever-like portion that is exposed the outside from the lower side of the seat surface 16 so as to be operated by an operating user (operator). The operator can displace the engageable member 27 forward by sliding the tilting operation portion 28 forward. This disengages the engageable member 27 from the engageable portions 24. Since the engageable member 27 is biased rearward by a spring or the like, when the operator stops the sliding operation of the tilting operation portion 28, the engageable member 27 engages with either one pair of the engageable portions 24.

The main body 10 can change the angle of the seat unit 11 with respect to the placement plane by means of the thus configured angle change mechanism 25. That is to say, in the state in which the engageable member 27 engages with the engageable portions 24, the seat unit 11 is positioned with respect to the supporting contact member 21. When the engageable member 27 is disengaged from the engageable portions 24, the seat unit 11 is rotatable about the rotational shafts 29 with respect to the supporting contact member 21. In this case, in accordance with the rotation of the seat unit 11 with respect to the supporting contact member 21, the two ends of the engageable member 27 moves inside the elongated hole portion 24b connected to the engageable portions 24. That is to say, the supporting contact member 21 is configured to be displaceable at least between a first position and a second position with respect to the seat unit 11. The angle change mechanism 25 may be considered to include not only the engageable member 27 and the tilting operation portion 28 but also the supporting contact member 21.

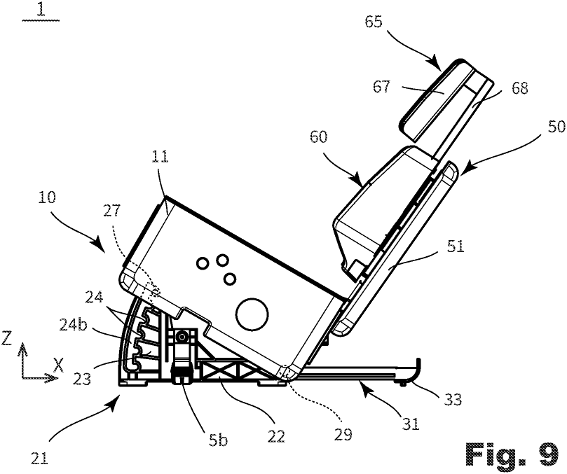

FIG. 9 is a side view showing a tilted state of the chair 1.

As shown in FIG. 9, in this embodiment, the chair 1 can be tilted from the non-tilted state shown in FIG. 4 to the tilted state where the seat unit 11 is tilted rearward by up to approximately 30 degrees at most. In this embodiment, the tilted angle of the seat unit 11 is determined by the position of the engageable portions 24 with which the engageable member 27 engages. In this embodiment, the seat unit 11 can be set to six different tilted angles from a minimum tilted angle (0 degrees) to a maximum tilted angle (approximately 30 degrees). This allows the preferred tilted angle to be set according to the user’s condition and application. As the seat unit 11 rotates with respect to the supporting contact member 21, the backrest 50 and the like supported by the seat unit 11 also rotate. It is possible to tilt the entire chair 1 while maintaining the user’s posture. The position and number of engageable portions 24 that can engage with the engageable member 27 are not limited to this. That is to say, the number of engageable portions 24 and the like may be changed to change the tilted angle that can be set. The angle change mechanism 27 may have an engageable member that can be displaced back and forth in the Y direction in accordance with an operation by the user, for example. Such a mechanism can be realized by using a link mechanism or the like as appropriate, for example.

Returning to FIG. 3, etc., the projecting member 31 is located on the lower side of the main body 10. In this embodiment, the projecting member 31 is configured to be able to be pulled out rearward from a state where it is accommodated inside the main body 10. That is to say, the projecting member 31 can be arranged so as to project rearward from the rear end of the main body 10 (the rear end of the seat unit 11). The projecting member 31 can be displaced with respect to the main body 10 so as not to project rearward from the main body 10. The projecting member 31 restricts rearward rotation of the entire main body 10 with respect to the placement plane in a state in which the projecting member is arranged so as to project rearward. That is to say, it is possible to suppress falling of the chair 1 rearward, by using the projecting member 31.

In this embodiment, the projecting member 31 is located so as to be slidable in the front-rear direction against the main body 10, between the bottom portion 22 of the supporting contact member 21 and the seat unit 11. The projecting member 31 is a resin component, for example, but may be constituted by a sheet metal component, a metal rod, or the like. The rear end of the projecting member 31 is provided with a supporting contact portion 33 extending substantially parallel to the Y direction. The supporting contact portion 33 is configured to be in contact with or located near the placement plane on which the main body 10 is installed, in the state in which the projecting member 31 projects rearward from the main body 10. The projecting member 31 may be constituted by multiple components that are independently displaceable with respect to the main body 10, for example. The projecting member 31 is not limited to being slidable against the main body 10. For example, it may be a detachable component that can be repositioned with respect to the main body 10 or a component that can be rotated with respect to the main body 10. In either case, it is sufficient that the projecting member 31 is configured to be capable of projecting rearward from the main body 10 and not projecting rearward from the main body 10.

As shown in FIG. 3, the backrest 50 includes an outer surface 51, the support portion 53, a rail 55, and a positioning mechanism 57. These portions are constituted by resin components. These portions may be partially or entirely made of other materials such as metal. The backrest 50 has a rectangular plate shape as a whole that is substantially identical to the external shape of the upper face of the main body 10.

The outer surface 51 is a portion that is located on the outside (the rear surface in the usable state) of the backrest 50. In this embodiment, the outer surface 51 is roughly in the shape of a flat plate, except for the periphery that is rounded. In this embodiment, the outer surface 51 is constituted by a single component, and is designed to have a simple texture.

The support portion 53 is located inside the backrest 50, and in the lower portion of the backrest 50 in the usable state. The support portion 53 is a portion having a shape corresponding to the holding portion 12 of the main body 10 and configured to be supported via the shaft 40 by the holding portion 12.

The rail 55 is located at the center in the left-right direction inside the backrest 50. The rail 55 is formed along a vertical direction, that is, a direction that is perpendicular to the Y direction. The rail 55 is configured to engage with the support member 60. Accordingly, the support member 60 is slidable against the backrest 50 along the rail 55.

The positioning mechanism 57 is located inside the backrest 50 so as to face the support member 60. The positioning mechanism 57 can position the support member 60 relative to the backrest 50. Various specific configurations of the positioning mechanism 57 can be employed. For example, the backrest 50 and the support member 60 can be engaged with each other as appropriate by a snap-fit using elasticity of resin or the like, or an unshown component such as a pin, for example. The positioning mechanism 57 can prevent the support member 60 from slipping down due to gravity or from being displaced when a slight external force is applied to the support member 60.

The support member 60 is attached to the inner side of the backrest 50 where a seated user is located. The support member 60 has a shape that enables the support member to support the seated user’s upper body. Specifically, for example, the support member 60 has a shape such that the outer end portions in the left-right direction protrude (rise) more forward than the center portion. Such raised portions regulate the position of the user’s torso in the left-right direction and can support the user’s upper body. The shape of the support member 60 is not limited to this and can be changed according to the purpose of use of the chair 1 and the like. The support member 60 may be shaped according to the individual user, and may be attached to or detached from the backrest 50 as appropriate.

The headrest 65 is arranged inside the backrest 50. The headrest 65 is configured to support the seated user’s head. The chair 1 may not include the headrest 65.

In this embodiment, the headrest 65 includes the pad 67, a prop 68, and a positioning portion 69. These portions are constituted by resin components, but may be made of other materials such as metal, for example.

The pad 67 is a portion that faces the user’s head. The pad 67 has a shape that enables the pad to support the user’s head. Specifically, for example, the pad 67 has a shape such that the outer end portions in the left-right direction protrude more forward than the center portion. Such end portions regulate the position of the user’s head in the left-right direction and can support the user’s head in the left-right direction. The shape of the pad 67 is not limited to this and can be changed according to the purpose of use of the chair 1 and the like. The pad 67 may be shaped according to the individual user, and may be attached to or detached from the backrest 50 as appropriate.

The pad 67 is attached to the prop 68. The prop 68 is in the shape of a bar having a length in the vertical direction, for example. In this embodiment, the prop 68 is located in the space provided between the backrest 50 and the support member 60. That is to say, the headrest 65 is supported by the backrest 50 such that the prop 68 is sandwiched between the backrest 50 and the support member 60 in the front-rear direction.

The positioning portion 69 is formed on the prop 68. In this embodiment, the positioning portion 69 is in the shape of step-like recesses and projections formed on the front surface of the prop 68, for example. That is to say, the portion of the support member 60 that faces the prop 68 has a snap-fit using elasticity of resin or the like that engages with the positioning portion 69. Accordingly, the position of the position of the headrest 65 is fixed. The positioning portion 69 may be configured by other engageable structures or the like.

The support member 60 is configured to be slidable in a predetermined direction against the backrest 50. That is to say, as described above, the support member 60 is displaceable along the rail 55. The support member 60 may not be displaceable. The support member 60 may not be attached to the backrest 50. In this case, the inner shape of the backrest 50 may be configured to support the user’s upper body as with the support member 60.

Furthermore, in this embodiment, the headrest 65 is configured to be displaceable in a predetermined direction with respect to the support member 60. Specifically, the headrest 65 is displaceable in the vertical direction with respect to the support member 60. The headrest 65 is attached to the support member 60. The headrest 65 is displaceable together with the support member 60, with respect to the backrest 50. The headrest 65 is displaceable with respect to the backrest 50 while the position of the support member 60 relative to the backrest 50 remains fixed.

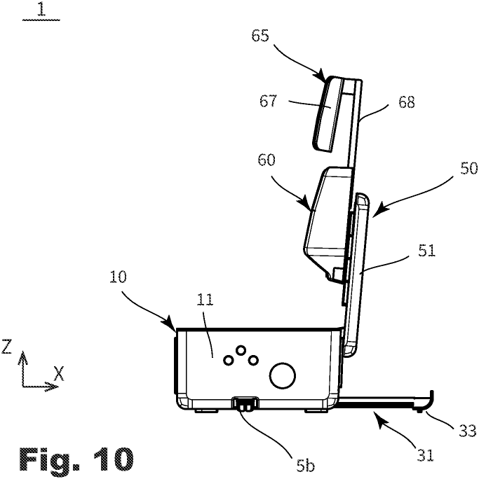

FIG. 10 is a side view showing an example of the state in which the support member 60 of the chair 1 is displaced.

As shown in FIG. 10, in the state in which the support member 60 has been displaced to the upper side, the distance from the seat surface 16 to the support member 60 and the headrest 65 is long. Therefore, it is possible to make the chair 1 easy to use for various users by displacing the support member 60 to an appropriate position according to the user’s physique and the like. In addition, it is possible to make the chair 1 easy to use for various users by displacing the headrest 65 to an appropriate position according to the user’s physique and the like.

Returning to FIG. 3, etc., the shaft 40 is interposed between the holding portion 12 of the main body 10 and the support portion 53 of the backrest 50. The shaft 40 serves as a rotational shaft when the backrest 50 rotates with respect to the main body 10. In this embodiment, the shaft 40 includes a buffer 41, a locking mechanism 45, and an opening/closing operating portion 46.

The buffer 41 is a so-called oscillation damper. The buffer 41 is arranged coaxially with the rotational shaft. The buffer 41 generates a resistance force when the backrest 50 rotates with respect to the main body 10. The buffer 41 is specifically configured to generate a resistance force when the backrest 50 is closed, but there is no limitation to this. This prevents the backrest 50 from rotating with respect to the main body 10 in a vigorous manner. Therefore, it is possible to prevent trapping of foreign matter not intended by the user between the main body 10 and the backrest 50 and the like or damage to the chair 1 when the chair is shifted from the usable state to the folded state.

The locking mechanism 45 in this embodiment can fix the position of the backrest 50 in the usable state relative to the main body 10. The locking mechanism 45 is provided with the opening/closing operating portion 46 that is operated by a user (operator) who performs the operation. The opening/closing operating portion 46 is arranged below the holding portion 12 of the seat unit 11 so as to project downward. In this embodiment, for example, a component that moves away from or closer to the support portion 53 in response to the operation of the opening/closing operating portion 46 is held on the holding portion 12 side. This component is biased by a spring toward the support portion 53. It is possible to hold the backrest 50 while preventing it from being displaced with respect to the main body 10, by causing this component to engage with the support portion 53 when the backrest 50 is in a predetermined posture in the usable state. The specific configuration of the locking mechanism 45 is not limited to those described above, and various structures can be employed. For example, a gear, a cam, or the like, and a component or the like configured to be engaged therewith may be used to lock the position of the backrest 50. The locking mechanism 45 can prevent the backrest 50 from rotating with respect to the main body 10 when not intended by the user. Therefore, it is possible to prevent trapping of foreign matter not intended by the user between the main body 10 and the backrest 50 and the like.

The locking mechanism 45 may be configured to fix the position of the backrest 50 relative to the main body 10 in the folded state. The locking mechanism 45 may be configured to fix the position of the backrest 50 relative to the main body 10 in both the usable state and the folded state. In this case, it is sufficient that the locking mechanism 45 is configured such that a component that moves away from or closer to the support portion 53 in response to the operation of the opening/closing operating portion 46 engages with the support portion 53 when the backrest 50 is in a predetermined posture in the folded state. The locking mechanism 45 provided so as to restrict the rotation of the backrest 50 in the folded state in this manner also can prevent the backrest 50 from rotating with respect to the main body 10 when not intended by the user.

As shown in FIG. 1, in this embodiment, the chair 1 includes first stickable portions 11b provided on the main body 10 and second stickable portions 50b provided on the backrest 50. The first stickable portions 11b are respectively provided on an upper front portion of the right armrest 13 and an upper front portion of the left armrest 14. The second stickable portions 50b are respectively provided in the vicinity of the upper left and right ends of the inner surface of the backrest 50. The first stickable portions 11b and the second stickable portions 50b are arranged so as to face each other when the backrest 50 is laid over the main body 10 in the folded state. At least either the first stickable portions 11b or the second stickable portions 50b are a magnet or the like. The magnetic attraction force acting between the first stickable portions 11b and the second stickable portions 50b causes the first stickable portions 11b and the second stickable portions 50b to be stuck together. Accordingly, in the folded state, the backrest 50 is kept laid over on the upper face of the main body 10. That is, in the folded state, even when an external force such as a shaking force is applied to the chair 1, the backrest 50 can be prevented from being somewhat displaced and wobbling with respect to the main body 10. In addition, the backrest 50 can be easily opened from the main body 10 when intended by the user. Therefore, the chair 1 can be easily shifted from the folded state to the usable state. Such stickable portions 11b and 50b may not be provided. For example, a hook and loop fastener or the like may be provided instead of or together with the stickable portions 11b and 50b. It is sufficient that the hook and loop fastener or the like can fix the backrest 50 and the main body 10.

Next, accessory members of the chair 1 will be described.

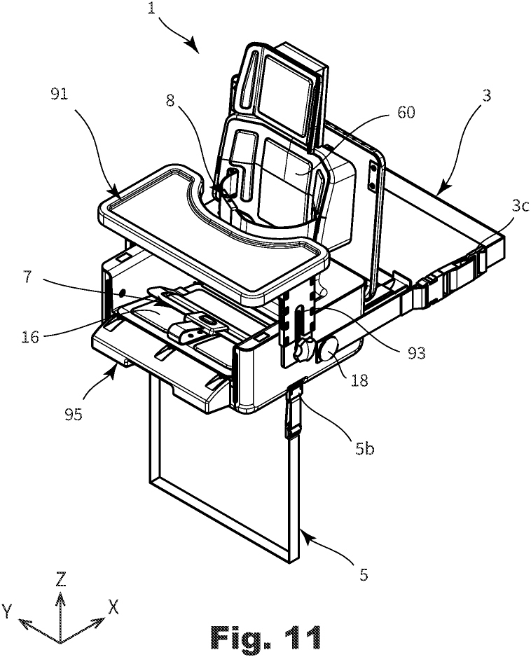

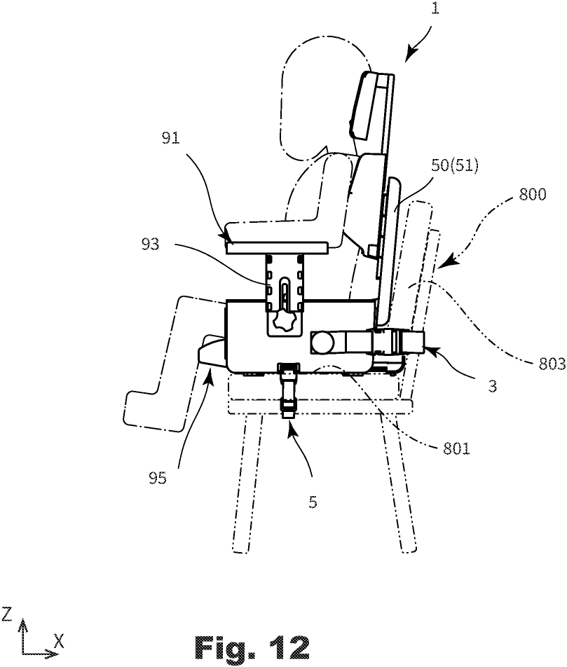

FIG. 11 is a perspective view showing an example of the state in which accessory members are attached to the chair 1. FIG. 12 is a side view showing a usage example of the chair 1.

As shown in FIGS. 11 and 3, in this embodiment, accessory members such as the strap 3, a fixing belt 5, a waist belt 7, and a chest belt 8 may be attached to the chair 1 as appropriate. Also, accessory members such as the table 91 and a knee support 95 may be attached to the chair 1 as appropriate.

In this embodiment, the seat unit 11 is configured such that the waist belt 7 can be attached thereto. As shown in FIG. 3, the waist belt 7 in this embodiment is fixed by three anchors 7b on the left and right sides of the waist and below the crotch. This regulates the position of the seated user’s waist and prevents the user from slipping down in the front direction. The user’s buttocks can be kept accommodated in the recess 15, and the user’s sitting posture can be maintained. The anchors 7b is displaceable in the front-rear direction, so that the waist belt 7 can be attached to an appropriate position according to the user’s physique and the like. The position of the anchors 7b is not limited to this. The anchors 7b may be displaceable in a direction that is different from the front-rear direction. The position of the anchors 7b may not be changeable.

Furthermore, in this embodiment, the support member 60 is configured such that the chest belt 8 can be attached thereto. As shown in FIG. 3, the chest belt 8 is fixed by two anchors 8b on the left and right sides of the chest. This regulates the position of the seated user’s chest and prevents the user from slipping down in the front direction or tilting to the left or right. The user’s upper body can be kept supported by the support member 60, and the user’s sitting posture can be maintained. The chest belt 8 may be in the shape of a ring that partially extends through a portion between the support member 60 and the backrest 50. The anchors 8b of the chest belt 8 may be provided on the backrest 50. That is to say, the chest belt 8 may be attached to the support member 60 or the backrest 50.

The form of belts for use in maintaining the user’s sitting posture is not limited to those described above. For example, the waist belt may also be a two-point belt. A belt that is connected to both the chest and waist belts at a buckle may also be used. A belt suitable for the user may be attached as appropriate to an anchoring portion or the like provided in advance on the chair 1.

The strap 3 is a belt that can be used to carry the chair 1. The strap 3 is attached such that the strap attachment portions 3b provided at the two ends thereof engage with the strap engageable portions 18 of the main body 10. The strap 3 in the shape of a ring may be attached to the main body 10 so as to pass through the main body 10. The strap 3 is provided with a length adjustment portion 3c so that the length between the two ends can be changed. The strap 3 has a buckle at which the belt can be unfastened and refastened. Therefore, it is easy to enclose other components with the strap 3 by unfastening and refastening the belt as necessary. In addition, when carrying the chair in the folded state as described later, it is easy to sling the strap 3 so-called across the body (to put the head and one arm through the strap 3 in the shape of a ring and sling it across the area from the right side of the torso to the left shoulder or the area from the left side of the torso to the right shoulder).

The fixing belt 5 is a belt that can be attached to the lower portion of the chair 1. The fixing belt 5 is attached to fixing belt attachment portions 5b on the left and right sides of the main body 10. In this embodiment, the fixing belt attachment portions 5b are attached to the outside of the left and right rising portions 23. The fixing belt attachment portions 5b are buckles that are paired with the ends of the fixing belt 5. In the state in which the ends of the fixing belt 5 are attached to the two fixing belt attachment portions 5b, the main body 10 and the fixing belt 5 are in the shape of a ring. It is preferable that the fixing belt 5 is configured such that its length can be adjusted.

The strap 3 and the fixing belt 5 can be used to regulate the position of the chair 1 in the usable state, for example. That is to say, a case as shown in FIG. 12 is assumed in which the chair 1 is used on a placement base 800 such as a dining chair, for example. It is assumed that the placement base 800 includes an installation plane 801 serving as a seat surface and a back portion 803 serving as a backrest portion. When placed on such a placement base 800, for example, the strap 3 can be placed around the back portion 803, and the length of the strap 3 can be adjusted to reduce slack. This allows the chair 1 to be restricted from moving forward against the placement base 800. For example, the fixing belt 5 can be placed around the installation plane 801 and the length of the fixing belt 5 can be adjusted to reduce slack. This can ensure that the chair 1 is less likely to slip out of place on the installation plane 801. Therefore, the chair 1 can be used without worry. In this embodiment, the strap 3 and the fixing belt 5 can be attached and detached so that they can be used only when necessary. To facilitate carrying the detached fixing belt 5 and the like together with the chair 1, the main body 10 is provided with an accommodation pocket 10b (shown in FIG. 3), for example. The accommodation pocket 10b is formed in the portion of the recessed 15 at the front side of the holding portion 12 that is recessed down from the periphery. That is to say, the accommodation pocket 10b has an opening in the recess 15. The fixing belt 5 that has been detached can be accommodated inside the accommodation pocket 10b. That is to say, in this embodiment, the fixing belt 5 can be accommodated inside the main body 10. The opening of the accommodation pocket 10b may be partially or entirely covered by a cover arranged on the seat surface 16 when the user is seated. The accommodation pocket 10b may be configured to accommodate accessory members different from the fixing belt 5.

The table 91 can be attached to and detached from the main body 10. As shown in FIG. 12, the table 91 is configured to be capable of being positioned in front of the seated user’s upper body and above waist and thighs. The table 91 includes two table props 93. The table props 93 are arranged to project downward from the vicinity of the right and left sides of the table 91. The left and right table props 93 are respectively attached to the table attachment portions 19 such that the table props 93 sandwich the side faces of the main body 10. The length of the table props 93 can be changed. That is to say, the table 91 is configured such that its height position relative to the seat surface 16 can be adjusted.

The knee support 95 can be attached to and detached from the main body 10. In this embodiment, the knee support 95 is attached to the front end of the seat unit 11. As shown in FIG. 12, the knee support 95 supports the portions of the seated user’s thighs that are closer to the knees. This allows the user to sit comfortably in the chair 1. The knee support 95 is formed such that the tilting operation portion 28 is kept exposed to the outside of the main body 10. This allows the tilted angle of the chair 1 to be changed even when the knee support 95 is attached.

Next, the chair 1 in the folded state will be described.

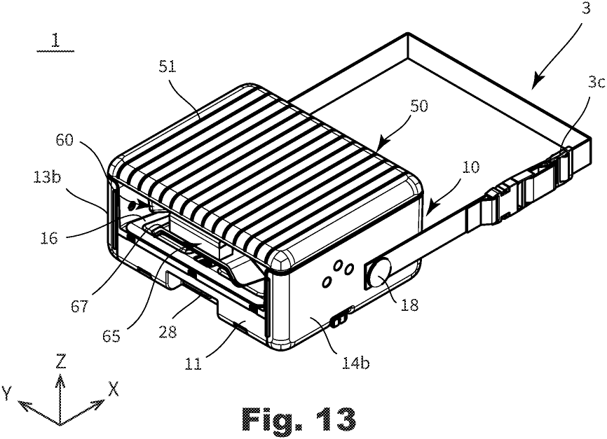

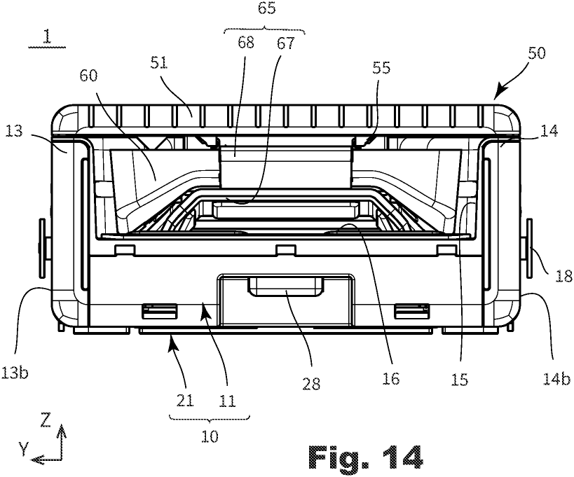

FIG. 13 is a perspective view showing a folded state of the chair 1. FIG. 14 is a front view showing a folded state of the chair 1.

FIG. 13 shows a state in which the strap 3 is attached to the chair 1. In this embodiment, the state of the chair 1 can be shifted as appropriate between the usable state in which a user can be seated and the folded state in which the backrest 50 covers the upper side of the seat surface 15. As shown in FIG. 13, the chair 1 is configured to have a box-like shape as a whole in the folded state. The box-like shape may also be said to be a shape of a cuboid, for example. The chair 1 in the folded state having a box-like shape in this manner can be easily carried by a user to various places. The straps 3 attached to the main body 10 can be used for carrying. This allows the user to more easily carry the chair 1 and to conveniently utilize the straps 3 as described above when using the chair 1.

In the folded state, the chair 1 has one or more faces (one or multiple faces) that are positioned so as to cover the left and right sides and the upper side of the seat surface 15. The one or more faces are constituted by the outer surfaces of the main body 10 and the outer surface of the backrest 50. That is to say, in this embodiment, the chair 1 is in the shape of a cuboid, and the chair 1 can be roughly said to have three faces consisting of an upper face and left and right faces so as to cover the seat surface 15. These three faces can be said to be constituted by the left and right outer surfaces of the main body 10 (i.e., the outer surface of the side panel 13b and the outer surface of the side panel 14b) and the outer surface 51 of the backrest 50. In this manner, the chair 1 having a box-like shape appears as one block or mass, giving the viewer an orderly impression. In this embodiment, the backrest 50 and the main body 10 are configured such that a difference between their outer face levels is slight except for the front side in the folded state. This gives a more orderly impression to the viewer. In this embodiment, the chair 1 is in the shape of a cuboid in the folded state, and thus it can be easily stored in a storage place and can be stored without dead space. When the chair 1 in the folded state is placed flat, a flat upper face can be obtained, and it can be used as a simple table or desk.

In the folded state, the components arranged inside the backrest 50, that is, the support member 60 and the headrest 65 are configured to face the seat surface 15. In this embodiment, these components such as the support member 60 and the headrest 65 are accommodated in the recess 15. In other words, the recess 15 is configured such that the support member 60 fits into the recess 15 in the folded state. Also, the recess 15 is configured such that the headrest 65 fits into the recess 15 in the folded state. This state can be said to mean that the support member 60 and the headrest 65 are located between the right armrest 13 and the left armrest 14 in the left-right direction. Since the chair is configured in this way, the chair 1 in the folded state can be made more compact. Therefore, the chair 1 can be more easily carried. The state in which the chair 1 is compact can be said to mean that the volume occupied by the chair 1 is small.

As shown in FIG. 14, the headrest 65 and the support member 60 are configured to overlap in this order in the direction from the inside to the outside of the chair 1 in the folded state. That is to say, the pad 67 of the headrest 65 is located above the seat surface 16. Also, the support member 60 is located above the pad 67. With this configuration, the chair 1 in the folded state can be made more compact. Such an overlap of the headrest 65 and the support member 60 can be achieved by providing a gap between the pad 67 and the prop 68 into which part of the support member 60 fits, for example. That is to say, when folding the chair, the headrest 65 is displaced downward with respect to the support member 60 such that the pad 67 overlaps the surface of the support member 60, and thus the headrest 65 and the support member 60 can be easily overlapped with each other.

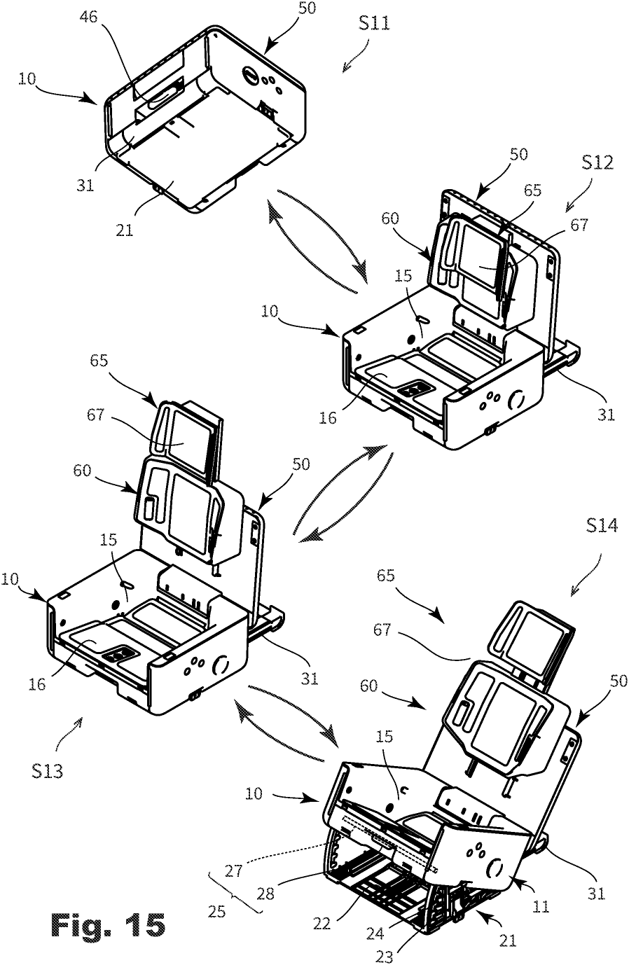

FIG. 15 is a view illustrating a shifting procedure from a folded state to a usable state of the chair 1.

FIG. 15 does not show accessory members. In the folded state shown as step S11, the chair 1 has a box-like shape as a whole. To shift the chair 1 from the folded state to the usable state, the user needs only to pull the vicinity of the upper end of the backrest 50 (the vicinity of the front end in the folded state) away from the main body 10. If the magnetic attraction force acting between the first stickable portions 11b and the second stickable portions 50b is set such that it can be canceled with light force, the chair 1 can be easily shifted to the usable state as necessary. The user pulls the projecting member 31 out of the main body 10, thereby causing the projecting member to project rearward. Accordingly, the state shown in step S12 is obtained.

In the state shown in step S12, the support member 60 is relatively lowered, and the support member 60 and the pad 67 of the headrest 65 overlap in the front-rear direction. Therefore, the positions of the support member 60 and the headrest 65 are adjusted to conform to the user. Accordingly, the chair 1 is shifted to the usable state shown in step S13 in which the user can be seated.

The chair 1 can be tilted rearward from the usable state shown in step S13. That is to say, for example, to obtain the tilted angle as shown in step S14, the user needs only to operate the tilting operation portion 28. The engagement of the engageable member 27 with the engageable portions 24 is once canceled and the seat unit 11 is made rotatable with respect to the supporting contact member 21, by performing a predetermined operation such as displacing the tilting operation portion 28 forward, for example. In this state, the seat unit 11 as well as the backrest 50 is rotated rearward. Then, the operation on the tilting operation portion 28 is canceled, and the engageable member 27 is caused to engage with another pair of engageable portions 24 corresponding to the current tilted angle, and thus the tilted angle can be fixed.

The chair 1 can be shifted from the usable state to the folded state by performing the steps from step S11 to step S14 in reverse order. To shift the chair 1 from the usable state to the storable state, the user needs only to operate the opening/closing operating portion 46. The backrest 50 is made rotatable with respect to the main body 10, by performing a predetermined operation such as sliding the opening/closing operating portion 46 rightward, for example. Then, in this state, the backrest 50 is displaced from the open state to the closed state. This ensures that the backrest 50 remains in the open state when no such intentional user operation is performed.

As explained above, according to this embodiment, the chair 1 is compact in the folded state. Therefore, the user can easily carry the chair 1. Since the chair 1 includes the main body 10 that can be installed on an installation plane, the chair can be easily used in any location, as long as there is an area where the main body 10 can be placed. It is extremely easy to shift the chair 1 from the folded state to the usable state or from the usable state to the folded state. Therefore, it is possible to provide a highly convenient chair 1 that can be easily carried and used in various places.

The chair 1 according to this embodiment can also be used as a chair having a so-called sitting posture maintaining function, for users who have difficulty in maintaining a sitting posture by themselves due to a functional disability in a part of their body. Conventional sitting posture maintaining devices are large and take up a lot of space, making it difficult to carry them to various places. On the other hand, the chair 1 according to this embodiment can be made into a small folded state as described above, and can be easily carried. Therefore, when the user goes out to various places, the user can easily carry the chair 1 to these places and easily use the sitting posture maintaining function.

### Description of Modified Examples

The configuration of the angle change mechanism is not limited to those described in the foregoing embodiment. For example, the chair can be configured to have a tilted angle by providing a kickstand-type supporting contact member instead of the supporting contact member 21 described above.

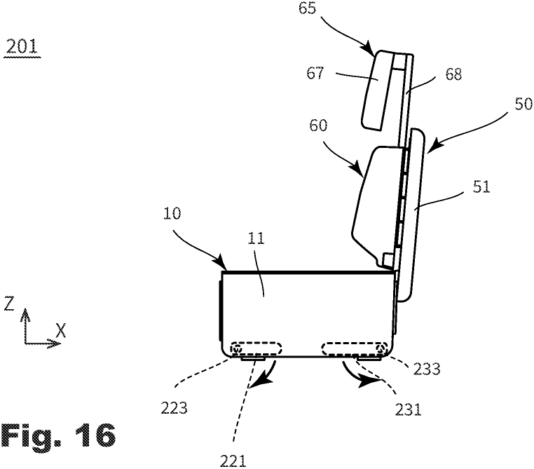

FIG. 16 is a side view of a chair 201 according to a modified example of the present invention.

As shown in FIG. 16, the chair 201 is different from the chair 1 in the following aspects with respect to the main body 10. That is to say, two supporting contact members 221 and 231 (a first supporting contact member 221 and a second supporting contact member 231) are provided instead of the supporting contact member 21 and the angle change mechanism 25 described above. The projecting member 31 is not provided.

The first supporting contact member 221 is located at the bottom of the main unit 10 near the front end. The first supporting contact member 221 is located in a first position that is above the bottom of the main unit 10 in the folded state and a state with no tilted angle. The first supporting contact member 221 is rotatably held with respect to the seat unit 11 in the direction indicated by the arrow in the drawing about a rotational shaft 223 provided on the front side, for example. The first supporting contact member 221 is rotatable up to a predetermined angle with respect to the seat unit 11. The position of the first supporting contact member 221 that has been rotated to this state may also be said to be a second position.

The second supporting contact member 231 is located at the bottom of the main unit 10 near the rear end. The second supporting contact member 231 is located above the bottom of the main unit 10 in the folded state and a state with no tilted angle. The second supporting contact member 231 is rotatably held with respect to the seat unit 11 in the direction indicated by the arrow in the drawing about a rotational shaft 233 on the rear side, for example. The second supporting contact member 231 is rotatable up to a predetermined angle with respect to the seat unit 11.

It is possible to make the chair 201 have a tilted angle by displacing the first supporting contact member 221 with respect to the seat unit 11 from the first position to the second position. The first supporting contact member 221 in the second position is in contact with a placement plane of the chair 201, thereby supporting the seat unit 11.

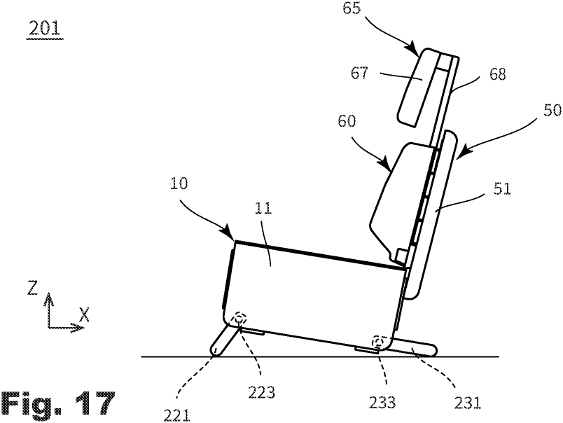

FIG. 17 is a side view showing a state in which the chair 201 is tilted.

In FIG. 17, the first supporting contact member 221 is in the second position. The second supporting contact member 231 is in the position obtained through rotation to a predetermined angle with respect to the seat unit 11 (hereinafter, referred to as a “tilted position”) from the position shown in FIG. 16 above. The second supporting contact member 231 serves as a projecting member arranged so as to project rearward from the rear end of the main body 10 in the tilted position.

In the state shown in FIG. 17, the first supporting contact member 221 and the second supporting contact member 231 are in contact with the placement plane, thereby making the chair 201 tilted rearward as a whole. In this case, the chair 201 is supported by the first supporting contact member 221 and the second supporting contact member 231 with respect to the placement plane. The second supporting contact member 231 is in contact with the placement plane on the rear side of the rear end of the main body 10, and thus the chair 201 is less likely to fall rearward.

The effects similar to those described above can be obtained with the chair 201 configured in this manner. Since the chair 201 has a simpler component configuration, the manufacturing cost of the chair 201 can be reduced. The angle of each of the supporting contact members 221 and 231 with respect to the seat unit 11 may be set or selected from among predetermined choices by the user. Accordingly, the angle can be set to multiple tilted angles.

### Others

The present invention is not limited to the embodiment set forth herein. Various modifications are possible within the scope of the present invention.

The configuration is not limited to those in the foregoing embodiment, and some of the constituent elements or functions of the foregoing embodiment may be omitted. The shape, size, and the like of each component of the chair may be changed as appropriate according to the user and purpose of use.

### INDUSTRIAL APPLICABILITY

As described above, the chair according to the present invention can be easily carried to various places, and thus it is useful as a chair and the like.

List of Reference Numerals

| | |
|---|---|
| 1, 201 | Chair |
| 3 | Strap |
| 5 | Fixing belt |
| 7 | Waist belt |
| 7b, 8b | Anchor |
| 8 | Chest belt |
| 10 | Main body |
| 11 | Seat unit |
| 11 b | First stickable portion |
| 12 | Holding portion |
| 13 | Right armrest |
| 14 | Left armrest |
| 13b, 14b | Side panel |
| 15 | Recess |
| 16 | Seat surface |
| 18 | Strap engageable portion |
| 19 | Table attachment portion |
| 21 | Supporting contact member |
| 22 | Bottom portion |
| 23 | Rising portion |
| 24 | Engageable portion |
| 24 b | Elongated hole portion |
| 25 | Angle change mechanism |
| 27 | Engageable member |
| 28 | Tilting operation portion |
| 29, 223, 233 | Rotational shaft |
| 31 | Projecting member |
| 33 | Supporting contact portion |
| 40 | Shaft |
| 41 | Buffer |
| 45 | Locking mechanism |
| 46 | Opening/closing operating portion |
| 50 b | Second stickable portion |
| 51 | Outer surface |
| 53 | Support portion |
| 60 | Support member |
| 65 | Headrest |
| 67 | Pad |
| 68 | Prop |
| 91 | Table |
| 93 | Table prop |
| 95 | Knee support |
| 221 | First supporting contact member |
| 231 | Second supporting contact member |

1. A chair comprising:
a main body having a seat surface and capable of being installed on an installation plane; and
a backrest rotatably attached to the main body,
wherein the chair is configured to have a box-like shape having one or more faces that are positioned so as to cover two lateral sides and an upper side of the seat surface in a folded state in which the backrest covers the upper side of the seat surface, and
the one or more faces are constituted by an outer surface of the main body and an outer surface of the backrest.

2. The chair according to claim 1, further comprising a support member attached to an inner side of the backrest where a seated user is located and capable of supporting the upper body of the seated user,
wherein the support member is attached so as to face the seat surface in the folded state.

3. The chair according to claim 2,
wherein the main body has a recess configured to accommodate the buttocks of the seated user,
a bottom of the recess is configured to serve as the seat surface, and
the recess is configured such that the support member fits into the recess in the folded state.

4. The chair according to claim 2, wherein the support member is configured to be slidable in a predetermined direction against the backrest.

5. The chair according to claim 2, further comprising a headrest arranged inside the backrest and capable of supporting the head of the seated user,
wherein the headrest is displaceable in a predetermined direction with respect to the support member, and
the headrest and the support member are configured to overlap in this order in the direction from the inside to the outside in the folded state.

6. The chair according to claim 1, further comprising a strap capable of engaging with the main body,
wherein the strap is configured to be changeable in length.

7. The chair according to claim 1, further comprising a projecting member arranged so as to project rearward from a rear end of the main body and configured to restrict rearward rotation of the entire main body with respect to the installation plane,
wherein the projecting member is displaceable with respect to the main body so as not to project rearward from the main body.

8. The chair according to claim 1,
wherein the main body includes:
a seat unit provided with the seat surface; and
a supporting contact member arranged at a bottom of the main body and configured to be in contact with the installation plane, thereby supporting the seat unit, and
the supporting contact member is configured to be displaceable at least between a first position and a second position with respect to the seat unit.
